(19) United States
(12) Patent Application Publication
(10) Pub. No.: US 2010/0086151 A1
(43) Pub. Date: Apr. 8, 2010

(54) Piezoelectric Speaker

(75) Inventor: Edwin Ruiter, Eindhoven (NL)

Correspondence Address: LIU & LIU, 444 S. FLOWER STREET, SUITE 1750, LOS ANGELES, CA, 90071, US

(73) Assignee: TPO Displays Corp.

(21) Appl. No.: 12/086,169

(22) PCT Filed: Dec. 1, 2006
(86) PCT No.: PCT/IB2006/054542

§ 371 Date: Dec. 7, 2009

(30) Foreign Application Priority Data
Dec. 7, 2005 (EP) 05111791.9

(51) Int. Cl. H04R 17/00

(52) U.S. Cl. 381/190

(57) ABSTRACT

The present invention relates to a piezoelectric speaker comprising a membrane, and an actuating layer comprising at least one piezoelectric element mounted to the membrane, which at least one piezoelectric element is adapted to, when actuated, cause the membrane to vibrate in order to generate sound. The speaker is characterized by means for varying the fraction of the actuating layer that is actuated depending on the sound frequency to be generated, wherein a smaller fraction of the actuating layer is actuated for higher sound frequencies. Varying the fraction of the actuating layer that is actuated depending on the sound frequency to be generated allows reduction of the power consumption of the speaker with maintained sound pressure level. The invention also relates to a method for driving a piezoelectric speaker.

### FIELD OF THE INVENTION

The present invention relates to a piezoelectric speaker comprising a membrane and an actuating layer comprising at least one piezoelectric element mounted to the membrane for causing, when actuated, the membrane to vibrate in order to generate sound. The present invention also relates to a method for driving a piezoelectric speaker.

### BACKGROUND OF THE INVENTION

FIGS. 1a-1b illustrate a basic prior art piezoelectric speaker 10 comprising a membrane 12, a piezoelectric element 14 mounted to the membrane, and a pair of electrodes 16, 18 for actuating the piezoelectric element in accordance with an electric input signal representative of the sound to be generated. When the piezoelectric element 14 is actuated it starts vibrating, and the vibration is converted by the membrane 12 to sound.

In general, piezoelectric speakers are well known for their power efficiency. This however is only true for lower frequencies. For higher frequencies, the impedance of the piezoelectric elements decreases, which in turn increases the current flow and thus the power consumption.

In an attempt to solve this problem, it has been proposed to regulate the voltage over the piezoelectric element. This solution is based on the understandings that the power consumption of a piezoelectric speaker is directly influenced by the voltage over the piezoelectric element (where the voltage depends on the input signal), and that the sound pressure level, increases for piezoelectric speakers at higher frequencies. Thus, it is possible to selectively lower the voltage for higher frequencies, as in an equalizer, with maintained sound pressure level and reduced overall power consumption.

### SUMMARY OF THE INVENTION

It is an object of the present invention to provide an alternative solution to the above mentioned problem of high power consumption at higher frequencies.

This and other objects that will be evident from the following description are achieved by means of a piezoelectric speaker and a method for driving a piezoelectric speaker, according to the appended claims.

According to an aspect of the invention, there is provided a piezoelectric speaker comprising a membrane, and an actuating layer comprising at least one piezoelectric element mounted to the membrane, which at least one piezoelectric element is adapted to, when actuated, cause the membrane to vibrate in order to generate sound, which speaker is characterized by variation means for varying the fraction of the actuating layer that is actuated depending on the sound frequency to be generated. Preferably, a reduced fraction of the actuating layer is actuated for higher sound frequencies.

Thus, the whole or only a portion or portions of the actuating layer can be actuated, depending on the frequency of the sound to be generated.

The present invention is based on several understandings. Firstly, the power consumption of a piezoelectric speaker is not only influenced by the voltage, but also by the capacitance of the piezoelectric element(s). Secondly, the capacitance of the piezoelectric element(s) can be reduced (and consequently the power consumption) by reducing the surface of the piezoelectric element(s). Thirdly, when the sound frequency increases, less piezoelectric material needs to be actuated in order to maintain the sound pressure level, due to the fact that piezoelectric speakers are more efficient in generating sound at higher frequencies. Thus, by varying the fraction of the actuating layer that is actuated depending on the sound frequency to be generated, wherein preferably a reduced fraction of the actuating layer is actuated for higher sound frequencies (and a larger fraction is actuated for lower sound frequencies), the power consumption can be lowered, while sound pressure level can be essentially maintained.

In one embodiment, the actuating layer comprises a single piezoelectric element. The fraction of the piezoelectric element that is actuated can be varied by selectively actuate a number of different portions of the piezoelectric element by means of an electric input signal representative of the sound to be generated, wherein the number of actuated portions depends on the frequency of the input signal.

In an embodiment with a single piezoelectric element, the variation means preferably comprises a segmented electrode provided on the piezoelectric element, the segmented electrode having individually activable segments corresponding to the portions of the piezoelectric element, whereby the different portions of the piezoelectric element can be individually actuated by supplying the input signal to a number of the electrode segments. Preferably, the segmented electrode is provided on one side of the piezoelectric element, while an unstructured electrode is provided on the opposite side of the piezoelectric element. In a piezoelectric material, only the material between the electrodes is actuated when the electrodes are activated. Thus, by having an electrode with individually activable or addressable segments, each segment covering a different portion of the piezoelectric element, it is possible to selectively actuate these portions of the piezoelectric element. Depending of which/how many portions that are actuated, the fraction of the total piezoelectric element that is actuated can be varied.

It should be noted that providing the piezoelectric element of a piezoelectric speaker with a segmented electrode is known per se from the document JP05-122793. In JP05-122793, the electrode segments are sized depending on the node of the higher resonance mode, and during operation, the driving voltage applied to the outside electrode is lower than the driving voltage applied to the inner electrode. This allows improvement of the peak and dip of sound pressure in the specific frequency caused by higher resonance and smoothing the sound pressure frequency characteristic. Thus, the segmented electrode in JP05-122793 is used for a different purpose and in a different way as compared to the present invention.

In order to control and determine the fraction of the piezoelectric element that is actuated, the variation means can for example comprise a plurality of parallel frequency filters, each filter being adapted to receive the input signal and being connected to at least one of the electrode segments. Thus, the input signal is allowed to pass a filter depending on the frequency of the input signal and the filter characteristics of the filter. Alternatively, the variation means can comprise a switch being connected to a frequency detector and having several output ports each connected to at least one of the electrode segments, wherein the switch is adapted to transfer the input signal to a number of the output ports depending on the frequency of the input signal as detected by the frequency detector. Both these alternatives offer solutions that are relatively easy to implement.

The piezoelectric speaker according to the present invention can for example be a flat panel speaker, and it can be implemented in various electronic devices such as mobile phones, PDAs, camcorders, plat panel displays, etc.

According to another aspect of the invention, there is provided a method for driving a piezoelectric speaker having a membrane and an actuating layer comprising at least one piezoelectric element mounted to the membrane, which at least one piezoelectric element is adapted to, when actuated, cause the membrane to vibrate in order to generate sound, which method is characterized by varying the fraction of the actuating layer that is actuated depending on the sound frequency to be generated, wherein a smaller fraction of the actuating layer is actuated for higher sound frequencies. This method offers similar advantages as the previously discussed aspect of the invention.

### BRIEF DESCRIPTION OF THE DRAWINGS

These and other aspects of the present invention will now be described in more detail, with reference to the appended drawings showing a currently preferred embodiment of the invention.

FIG. 1a is a schematic side view of a piezoelectric speaker according to prior art;

FIG. 1b is a schematic top view of the prior art speaker of FIG. 1a;

FIG. 2a is a schematic cross-sectional side view of a piezoelectric speaker according to an embodiment of the present invention;

FIG. 2b is a schematic top view of the speaker of FIG. 2a;

FIG. 3a illustrates a filtering arrangement coupled to a piezoelectric speaker according to an embodiment of the present invention;

FIG. 3b illustrates a frequency dependent switch coupled to a piezoelectric speaker according to an embodiment of the present invention;

FIG. 4 illustrates the power consumption for a speaker of the type illustrated in FIGS. 2a-2b;

FIG. 5 illustrates sound pressure levels for a speaker of the type illustrated in FIGS. 2a-2b; and

FIGS. 6a-6f illustrate various shapes of electrode segments.

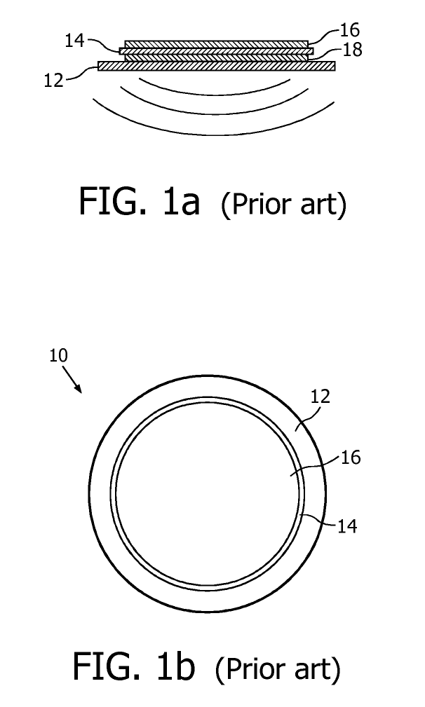

### DETAILED DESCRIPTION OF THE PREFERRED EMBODIMENT

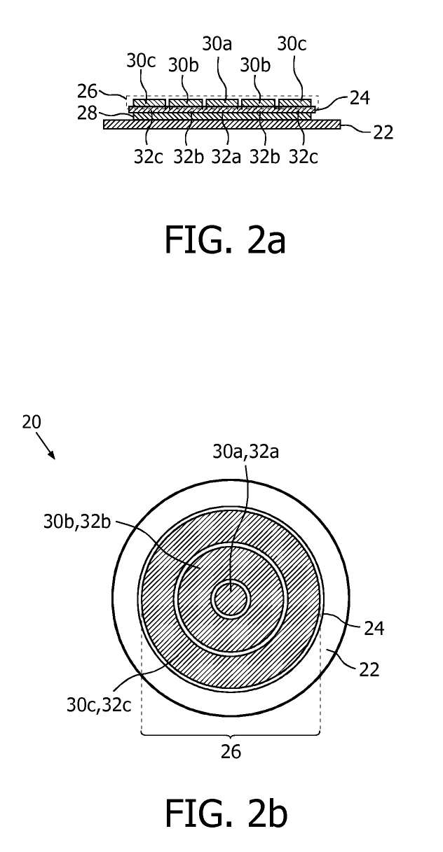

FIGS. 2a-2b illustrate a piezoelectric speaker 20 according to an embodiment of the present invention. The speaker 20 comprises a membrane 22 and a piezoelectric element 24 mounted to the membrane 22.

A segmented electrode 26 is further provided on one side of the piezoelectric element 24, and an unstructured electrode 28 is provided on the other side of the piezoelectric element 24. The unstructured electrode 28 is preferably provided between the membrane 22 and the piezoelectric element 24, as illustrated in FIG. 2a.

The segmented electrode 26 comprises three individually addressable segments 30a, 30b and 30c. The segments are a disc (30a) and two rings (30b and 30c).

In a piezoelectric material, only the material between the electrodes is actuated when the electrodes are activated. Thus, when for example the electrode segment 30a is activated (together with the unstructured electrode 28), only a portion 32a of the piezoelectric element 24 which corresponds to the segment 30a is actuated. Similarly, portion 32b of the piezoelectric element 24 corresponds to segment 30b, and portion 32c corresponds to segment 30c. Since the segments 30 of the segmented electrode 26 are individually addressable, any number and combinations of portions 32 of the piezoelectric element 24 can be actuated at any time. Thus, the fraction of the piezoelectric element 24 that is actuated can be varied during operation of the speaker, which effectively means that the surface area of the piezoelectric element 24 can be varied.

Upon operation of the piezoelectric speaker 20, the unstructured electrode 28 and any number of segments 30 of the segmented electrode 26 are activated in order to actuate corresponding portions 32 of the piezoelectric element 24 is accordance with an electric input signal representative of the sound to be generated. The portions 32 of the piezoelectric elements that are actuated starts vibrating, and the vibration is transferred to the membrane 22, which membrane 22 converts the vibration to sound.

As mentioned above, due to the fact that piezoelectric speakers are more efficient in generating sound at higher frequencies, less piezoelectric material needs to be actuated when the sound frequency increases with maintained sound pressure level. Thus, which portions 32 (i.e. how large fraction) of the piezoelectric element 24 to actuate should be determined based on the sound frequency to be generated. It should further be recalled that the capacitance of a piezoelectric element can be reduced (and consequently the power consumption) by reducing the surface of the piezoelectric element. Thus, in order to lower the power consumption and at the same time maintain the sound pressure level, a larger fraction of the piezoelectric element should be actuated for lower sound frequencies, and a smaller fraction of the piezoelectric element should be actuated for higher sound frequencies.

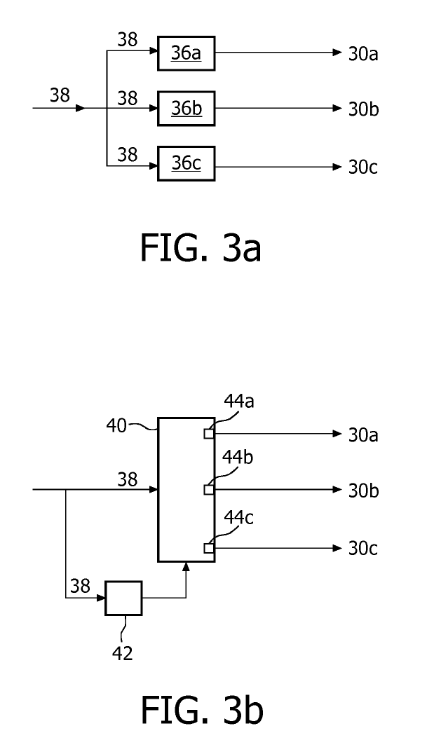

In order to implement these understandings and conditions, a filter arrangement, as illustrated in FIG. 3a, or a frequency dependent switch, as illustrated in FIG. 3b, can be used.

FIG. 3a illustrates a filter arrangement comprising three filters 36a-36c having different filter characteristics. Each filter 36 receives an electric input signal 38, which signal 38 is representative of the sound to be generated (thus, the frequency of the signal 38 corresponds to the sound frequency to be generated). Each filter 36a-36c is further coupled to a corresponding segment 30a-30c of the segmented electrode 26. Thus, each filter either allows the input signal 38 to pass to the corresponding segment 30 resulting in actuation of the portion 32 of the piezoelectric element associated with that segment 30, or it blocks the input signal 38, depending the frequency of the input signal 38 and the filter characteristics of the specific filter 36.

In line with the above discussion, the filters 36 can for example be configured so that a low frequency signal is allowed to pass all filters 36a-36c resulting in actuation of essentially the whole piezoelectric element 24, a medium frequency signal is allowed to pass the filters 36a-36b to the segments 30a and 30b resulting in actuation of the corresponding portions 32a and 32b of the piezoelectric element 24, and a high frequency signal is allowed to pass only the filter 36a resulting in actuation of the corresponding portion 32a only.

Instead of the filter arrangement of FIG. 3a, a switch 40 connected to a frequency detector 42 as illustrated in FIG. 3b can be used. Both the switch 40 and the detector 42 receive the electric input signal 38. The switch 40 further comprises three output ports 44a-44c, each being coupled to a corresponding segment 30a-30c of the segmented electrode 26. Upon operation, the switch 40 transfers the input signal 38 to one or several of the output ports 44 (and thus to one or several of the segments 30) depending on the frequency of the input signal detected by the frequency detector 42.

Again in line with the above discussion, the switch 40 and the frequency detector 42 can for example be configured so that a low frequency signal is transferred to all output ports 44a-44c resulting in actuation of essentially the whole piezoelectric element 24, a medium frequency signal is transferred via output ports 44a-44b to the segments 30a and 30b resulting in actuation of the corresponding portions 32a and 32b of the piezoelectric element 24, and a high frequency signal is transferred only to output port 44a resulting in actuation of the corresponding portion 32a only.

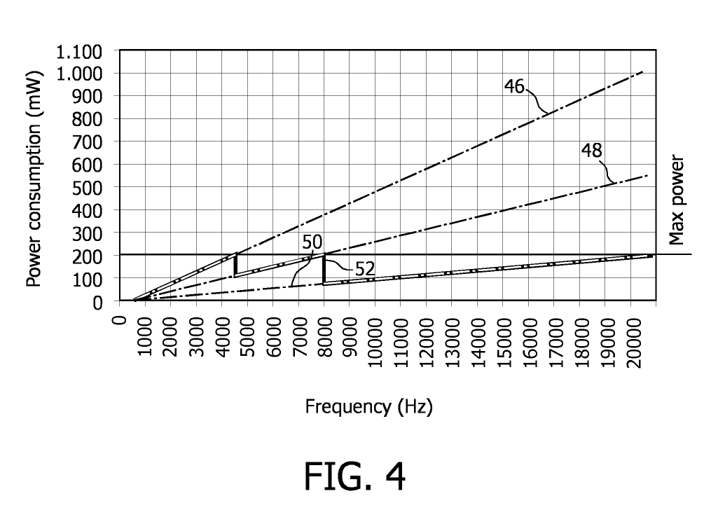

FIG. 4 illustrates, in the context of a piezoelectric speaker of the type illustrated in FIGS. 2a-2b, the relationship between power consumption and sound frequency for different piezoelectric element surface areas. Graph 46 indicates power consumption in relation to frequency for a piezoelectric element surface area corresponding to the portions 32a+32b+32c, i.e. essentially the whole piezoelectric element 24 is actuated. Similarly, graphs 48 and 50 indicate power consumption in relation to frequency for portions 32a+32b and portion 30a, respectively.

From FIG. 4 it can be noted that in general the power consumption increases when the frequency increases. In particular, for a prior art speaker where the whole piezoelectric element is actuated (equivalent to graph 46), power consumption rapidly increases with frequency, while the increase is less significant for a smaller piezoelement area. However, when designating certain frequency ranges to one or more portions of the piezoelectric element (i.e. allowing variation of the fraction of the piezoelectric element that is actuated depending on the sound frequency to be generated) according to the invention, the power consumption can be lowered. In this example, low frequencies (<4.5 kHz) are transmitted to electrode segments 30a+30b+30c resulting in actuation of portions 32a+32b+32c of the piezoelectric element, while mid frequencies (4.5-8 kHz) are only transmitted to segments 30a+30b actuating portions 32a+32b and high frequencies (>8 kHz) only to segment 30a actuating portion 32a. The resulting power consumption-frequency relationship is indicated by graph 52 shown in bold. As can be seen, in this example, the maximum power consumption for the piezoelectric speaker has been decreased to about 200 mW.

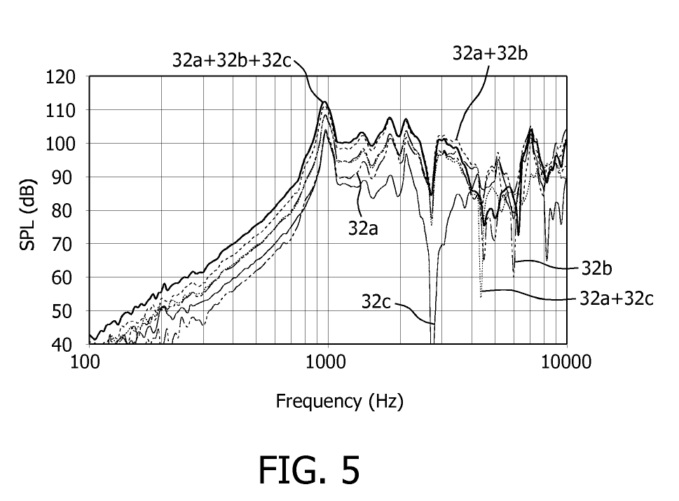

FIG. 5 further illustrates, in the context of a piezoelectric speaker of the type illustrated in FIGS. 2a-2b, measured sound pressure level in relation to sound frequency for different piezoelectric element surface areas. The graphs show that for low frequencies (<1000 Hz in this example), the number of portions of the piezoelectric element that are actuated significantly influence the sound pressure level. The more portions, the larger piezoelement surface area, the higher sound pressure level. However, above about 1800 Hz, only actuating portions 32a+32b is sufficient to maintain the same sound pressure level as actuating portions 32a+32b+32c together. Further up in frequency starting at about 4100 Hz portion 32a performs the same as portions 32a+32b together. The results in FIG. 5 confirm that a piezoelectric speaker's efficiency increases with frequency, and that at higher frequencies less actuated piezoelement portions are necessary to maintain the same sound pressure level.

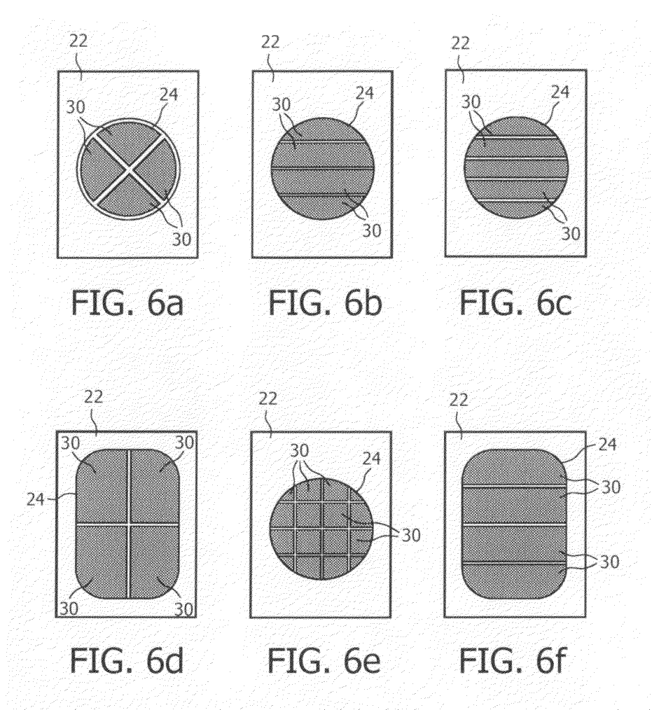

The person skilled in the art realizes that the present invention by no means is limited to the preferred embodiments described above. On the contrary, many modifications and variations are possible within the scope of the appended claims. For example, even though a segmented electrode having three segments has been illustrated above, a segmented electrode having two segments or more than three segments could also be used (with a corresponding number of piezoelement portions, filters, etc). Also, many different shapes of electrode segments and corresponding piezoelement portions can be implemented, examples of which are illustrated in FIGS. 6a-6f.

Further, it should be noted that the filter arrangement of FIG. 3a or the frequency dependent switch of FIG. 3b also could be used in embodiments other than the embodiment with a single piezoelectric element and a segmented electrode as disclosed above. For example, in an alternative embodiment, several piezoelectric element can be mounted to the membrane, wherein each piezoelectric element is provided with an electrode which selectively can be activated with the input signal by means of the above mentioned filter arrangement or the frequency dependant switch. In such an embodiment, each filter or switch output port is connected to at least one of the electrodes.

1. A piezoelectric speaker, comprising:
a membrane;
an actuating layer comprising at least one a piezoelectric element mounted to said membrane, which at least one piezoelectric element is adapted to, when actuated, cause said membrane to vibrate in order to generate sound, and
variation means for varying the fraction of the actuating layer that is actuated depending on the sound frequency to be generated.

2. A piezoelectric speaker according to claim 1, wherein a reduced fraction of said actuating layer is actuated for higher sound frequencies.

3. A piezoelectric speaker according to claim 1, wherein said actuating layer comprises a single piezoelectric element.

4. A piezoelectric speaker according to claim 3, wherein said variation means is adapted to selectively actuate a number of different portions of said piezoelectric element by means of an electric input signal representative of the sound to be generated, wherein the number of actuated portions depends on the frequency of said input signal.

5. A piezoelectric speaker according to claim 4, wherein said variation means comprises a segmented electrode provided on one side of the piezoelectric element, said segmented electrode having individually activable segments corresponding to the portions of said piezoelectric element, whereby said portions can be individually actuated by supplying said input signal to a number of said electrode segments.

6. A piezoelectric speaker according to claim 5, wherein said segmented electrode is provided on one side of the piezoelectric element, while an unstructured electrode is provided on the opposite side of the piezoelectric element.

7. A piezoelectric speaker according to claim 5, wherein said variation means comprises a plurality of parallel frequency filters, each filter being adapted to receive said input signal and being connected to at least one of said electrode segments.

8. A piezoelectric speaker according to claim 5, wherein said variation means comprises a switch being connected to a frequency detector and having several output ports each connected to at least one of said electrode segments, wherein said switch is adapted to transfer said input signal to a number of said output ports depending on the frequency of said input signal as detected by said frequency detector.

9. A piezoelectric speaker according to claim 1, said speaker being a flat panel speaker.

10. A method for driving a piezoelectric speaker having a membrane and an actuating layer comprising at least one piezoelectric element mounted to said membrane, which at least one piezoelectric element is adapted to, when actuated, cause said membrane to vibrate in order to generate sound, the method including the step of:
varying the fraction of the piezoelectric element that is actuated depending on the sound frequency to be generated.

11. A piezoelectric speaker according to claim 2, wherein said actuating layer comprises a single piezoelectric element.
